(19) United States
(12) Patent Application Publication
(10) Pub. No.: US 2009/0027418 A1
(43) Pub. Date: Jan. 29, 2009

(54) Map-based interfaces for storing and locating information about geographical areas

(76) Inventors: Nimit H. Maru, Sunnyvale, CA (US); David Yang, Sunnyvale, CA (US)

Correspondence Address: YAHOO C/O MOFO PALO ALTO, 755 PAGE MILL ROAD, PALO ALTO, CA, 94304, US

(21) Appl. No.: 11/880,912

(22) Filed: Jul. 24, 2007

(51) Int. Cl. G09G 5/00

(52) U.S. Cl. 345/629

(57) ABSTRACT

User interfaces and computer enabled methods for defining, discovering, and viewing map layers are provided. The map layers annotate an existing map by providing additional information that is not present in the existing map. A contribution user interface receives and configures the map layer on a web browser. The contribution user interface allows the map layer to be positioned over a desired location and displayed as a semi-transparent image overlay superimposed over the existing map. The map layer may be enlarged, reduced, and rotated to match the features of the existing map. The map layer is stored for use by other users. The layer may be retrieved by users who search for the desired location or for related or nearby locations. The layer may be displayed as a search result, and may be displayed for viewing by users as a partially-transparent image overlay over the existing map.

### FIELD

The present application relates generally to geographical maps, and more specifically to user interfaces for displaying annotations and images with geographical maps.

### RELATED ART

Map services and applications such as Yahoo!® Maps display geographic maps that are useful for finding locations of and directions to geographic locations such as street addresses and features such as airports and government buildings. However, such map services generally do not provide information about the locations. The locations themselves are often displayed as grey or blank space on the map. Furthermore, many types of locations, such as special-interest locations, are not displayed by these map services.

Many detailed maps of particular locations are available as images on the Internet, such as parking maps, maps of special-interest routes, such as bicycle routes and walking tours, and detailed maps of locations, such as stadium seating maps, museum maps, or college campus maps. Furthermore, there may be several ways to view a location. For example, a baseball stadium may have different seating arrangements for concerts and baseball games.

It would be desirable, therefore, to provide more detailed information on the map services, so that the comprehensive maps include detailed information and allow for multiple views of a particular area.

### SUMMARY

In general, in a first aspect, the invention features a computer program product comprising program code for receiving at least one map layer to annotate a map base, the program code comprising receiving the at least one map layer, causing the display of the at least one map layer as a semi-transparent image on the map base, causing the display of the semi-transparent image in a position relative to the map base in response to receipt of at least one geometry parameter, the semi-transparent image adjusting in response to the at least one geometry parameter, communicating the at least one map layer to a server for storage. Embodiments of the invention may include one or more of the following features. The computer program product may be located at a web browser, and the computer program product may be provided by a server to the web browser.

In general, in a second aspect, the invention features a computer program product comprising program code for enabling annotation of a map base, the program code comprising receiving at least one image and at least one geometry parameter from a layer contribution user interface via a computer network, wherein the at least one geometry parameter specifies a location on the map base for the at least one image; and storing the at least one map image in association with the at least one geometry parameter in a layers database.

Embodiments of the invention may include one or more of the following features. The program code may include receiving at least one text annotation, wherein the at least one text annotation may be associated with the at least one image; and storing the at least one text annotation in association with the at least one map image in the layers database. The program code may include generating at least one tile based upon the at least one map layer, rotating and scaling the at least one tile based upon the at least one geometry parameter, and storing the at least one tile in a tiles database, wherein the at least one tile may be associated with the at least one map layer. The program code may include dividing the at least one map layer into the at least one tile.

In general, in a third aspect, the invention features a computer program product comprising program code for enabling browsing of at least one map layer associated with a map base, the program code comprising receiving a search string from a user, communicating the search string to a server, receiving at least one search result from the server, causing the display of the at least one search result, receiving selection of a selected result, and causing the display of a map layer that corresponds to the selected result, wherein the map layer may be displayed as a semi-transparent image superimposed upon the map base at a location specified by a position coordinates parameter associated with the map layer.

In general, in a fourth aspect, the invention features a computer enabled method of enabling contribution of a map layer to annotate a map base, the method comprising receiving the at least one map layer from a user, causing the display of the at least one map layer as a semi-transparent image on the map base in a position relative to the map base, in response to receipt of at least one geometry parameter, wherein the position is based upon the at least one geometry parameter, and communicating the at least one map layer to a server for storage. Embodiments of the invention may include one or more of the following features. The method may be executed on a web browser.

The at least one geometry parameter may include a position coordinates parameter, a layer dimensions parameter, a layer orientation parameter, or a combination thereof. The location of the semi-transparent image on the map base may be based upon the position coordinates parameter. The size of the semi-transparent image may be based upon the layer dimensions parameter. The orientation of the semi-transparent image may be based upon the layer orientation parameter.

The method may further include moving the semi-transparent image in response to user input received via the web browser, scaling the semi-transparent image in response to user input received via the web browser, and/or rotating the semi-transparent image in response to user input received via the web browser.

In general, in a fifth aspect, the invention features a computer enabled method of enabling discovery of a map layer, the method comprising causing the display of a layer discovery user interface for discovering at least one map layer via a web browser, wherein the at least one map layer is associated with at least one map location on a map base, wherein the layer discovery user interface is operable to receive a desired location via the web browser, communicate the desired location to a server, receive a map layer from the server, wherein the map layer is associated with the desired location, cause the display of the map layer as a semi-transparent image superimposed on at least a portion of the map base, and wherein the portion of the map base overlaid by the map layer is defined by at least one geometry parameter associated with the map layer.

Embodiments of the invention may include one or more of the following features. The map layer may include at least one tile, and the layer discovery user interface may cause the display of the at least one tile on the map base, wherein the location at which the at least one tile is displayed may be defined by at least one geometry parameter associated with the at least one tile. The layer discovery user interface may cause partial color blending of the map layer with the at least a portion of the map base to allow features of the map layer and features of the at least a portion of the map base to be visible, wherein the degree to which features of the at least a portion of the map base are visible may be based upon an opacity value.

In general, in a sixth aspect, the invention features an interface for receiving at least one map layer to annotate a map base, the interface comprising an input portion for receiving the at least one map layer, and an overlay for displaying the at least one map layer as a semi-transparent image, the semi-transparent image adjusting in response to input received from a user, wherein the interface is located on a web browser.

Embodiments of the invention may include one or more of the following features. The overlay may move the semi-transparent image in response to user input received via the web browser. The overlay may scale the semi-transparent image in response to user input received via the web browser. The overlay may rotate the semi-transparent image in response to user input received via the web browser.

In general, in a seventh aspect, the invention features an interface for displaying at least one map layer as an overlay on a map base, the interface comprising an input portion for receiving a search string from a user, a display for displaying at least one search result, wherein the at least one search result matches the search string, an input portion for receiving selection of a selected result, wherein the at least one map layer corresponds to the selected result, wherein the at least one map layer is displayed as a semi-transparent image at a location specified by a position coordinates parameter associated with the at least one map layer, and wherein the interface is located on a web browser. Embodiments of the invention may include one or more of the following features. The interface may further include an opacity control for adjusting an opacity value of the semi transparent image. A size and an orientation of the at least one semi-transparent image may be based upon at least one geometry parameter associated with the map layer. The at least one geometry parameter may include a position coordinates parameter, a layer dimensions parameter, a layer orientation parameter, or a combination thereof. The location of the semi-transparent image on the map base may be based upon the position coordinates parameter. The size of the semi-transparent image may be based upon the layer dimensions parameter. The orientation of the semi-transparent image may be based upon the layer orientation parameter.

In general, in an eighth aspect, the invention features an apparatus for receiving at least one map layer to annotate a map base, the apparatus comprising input logic for receiving the at least one map layer, and display logic for displaying the at least one map layer as a semi-transparent image, the semi-transparent image adjusting in response to input received from a user, wherein the interface is located on a web browser. Embodiments of the invention may include one or more of the following features. The display logic may move, rotate, and scale the semi-transparent image in response to user input received via the web browser.

In general, in a ninth aspect, the invention features an apparatus for displaying at least one map layer as an overlay on a map base, the apparatus comprising input logic for receiving a search string from a user, display logic for displaying at least one search result, wherein the at least one search result matches the search string, input logic for receiving selection of a selected result, wherein the at least one map layer corresponds to the selected result, the at least one map layer is displayed as a semi-transparent image at a location specified by a position coordinates parameter associated with the at least one map layer, and the apparatus is located on a web browser. Embodiments of the invention may include one or more of the following features. The apparatus may include opacity control logic for adjusting an opacity value of the semi transparent image. A size and an orientation of the at least one semi-transparent image may be based upon at least one geometry parameter associated with the map layer. The at least one geometry parameter may include a position coordinates parameter, a layer dimensions parameter, a layer orientation parameter, or a combination thereof.

The location of the semi-transparent image on the map base may be based upon the position coordinates parameter. The size of the semi-transparent image may be based upon the layer dimensions parameter. The orientation of the semi-transparent image may be based upon the layer orientation parameter.

### BRIEF DESCRIPTION OF THE DRAWINGS

The present application can be best understood by reference to the following description taken in conjunction with the accompanying drawing figures, in which like parts may be referred to by like numerals:

FIG. 1 is an illustrative drawing of a web-based system for viewing and annotating geographic maps in accordance with embodiments of the invention.

FIG. 2 is an illustrative drawing of layer contribution user interface logic in accordance with embodiments of the invention.

FIG. 3 is an illustrative drawing of layer contribution server logic for annotating geographic maps in accordance with embodiments of the invention.

FIG. 4 is an illustrative drawing of layer discovery user interface logic in accordance with embodiments of the invention.

FIG. 5 is an illustrative drawing of layer discovery server logic in accordance with embodiments of the invention.

FIGS. 6A-6G are illustrative drawings of layer contribution user interfaces in accordance with embodiments of the invention.

FIGS. 7A and 7B are illustrative drawings of layer discovery user interfaces in accordance with embodiments of the invention.

FIG. 7C is an illustrative drawing of layer tiles in accordance with embodiments of the invention.

FIG. 7D is an illustrative drawing of layer geometry transformations in accordance with embodiments of the invention.

FIG. 8 is an illustrative drawing of a layer contribution user interface process in accordance with embodiments of the invention.

FIG. 9 is an illustrative drawing of a layer contribution server-side process in accordance with embodiments of the invention.

FIGS. 10A and 10B are illustrative drawings of a layer discovery user interface process in accordance with embodiments of the invention.

FIGS. 11A and 11B are illustrative drawings of a layer discovery server-side process in accordance with embodiments of the invention.

FIG. 12 is an illustrative drawing of an exemplary computer system that may be used in accordance with some embodiments of the invention.

### DETAILED DESCRIPTION

The following description is presented to enable a person of ordinary skill in the art to make and use the invention, and is provided in the context of particular applications. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

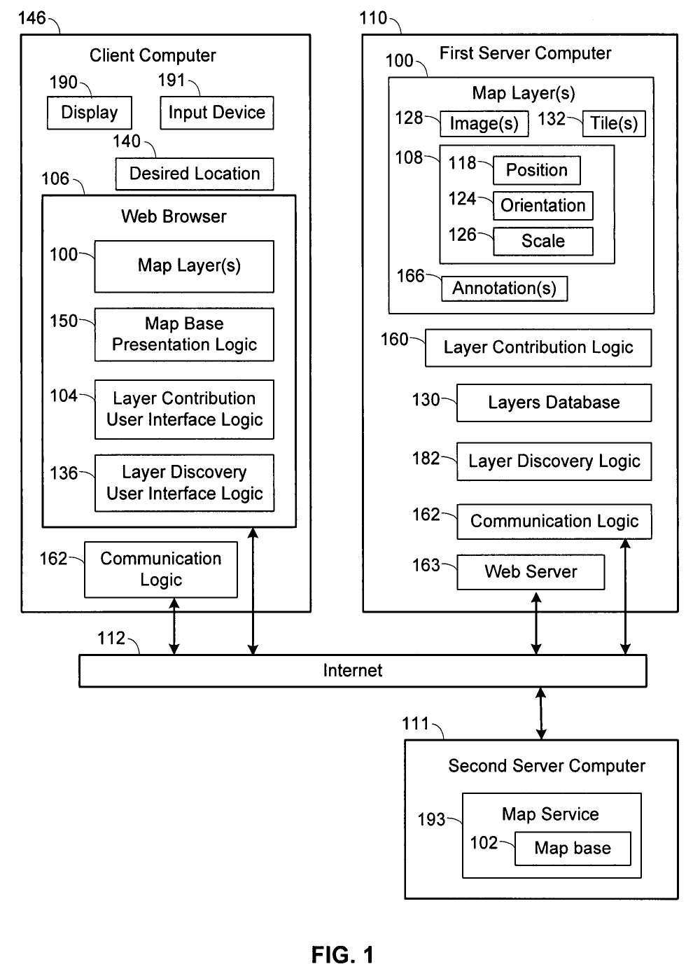

FIG. 1 is an illustrative drawing of a web-based system for viewing and annotating geographic maps in accordance with embodiments of the invention. A client 146 computer includes components that enable a user (not shown) to contribute, i.e., provide a map layer 100, map annotations 166, and related information to be displayed on a map base 102 by a display 190 to augment the map base 102 with additional information, such as more detailed maps of certain locations, locations of special-interest that are not on the map base 102, or special routes, such as train routes, tourist routes, or hiking routes. The map base 102 may be, for example, a map of a geographic region showing roads, locations of interest, driving directions, and the like, such as those displayed by Yahoo!® Maps. A first server computer 110 provides for storage and retrieval of the map layer 100 in a layers database 130 and processing of the map layer 100, such as division of the map layer 100 into tiles 132. The map layer 100 may be transmitted between the client computer 146 and the server computer 110 via a network 112 using communication protocols such as Hypertext Transport Protocol (HTTP). In one example, the map layer 100 includes a graphical image 128 of the additional information to be displayed as an overlay on the map base 102, geometry parameters 108 that describe the position 118, orientation 124, and scale 126 of the graphical image 128, and annotations 166 such as a text description of the layer and additional text descriptions to be displayed at specified locations on the map base 102.

In one example, a web browser 106 executing on the client computer 146 communicates with a web server 163 executing on a first server computer 110 and with a map service 193 executing on a second server computer 111. Communication is via a network 112 such as the Internet. Data such as request messages, e.g., HTTP requests, may be sent from the web browser 106 to the web server 163, and data such as response messages, e.g., HTTP responses, may be sent from the web server 163 to the web browser 106. The response messages contain data to be displayed on a display 190 of the client computer 146. The display 190 may present a text or graphics image 128 that appears on a monitor of the computer 146. The user may view the display 190 and may interact with an input device 191 to provide data such as text characters and user interface actions to the web browser 106. The input device 191 may be, for example, a mouse, a keyboard, or any other device for providing data to the client computer 146.

In another example, the web browser 106, the web server 163, and the map service 193 may execute on a single computer, e.g., the client computer 146 (without use of the network 112), or may be distributed across computers in any other configuration. In another example, the web browser 106 may execute on the client computer 146, and the web server 163 and map service 193 may execute on the first server computer 110. In other example, there may be multiple web browsers 106 executing on multiple client computers 146, communicating with multiple web servers 163 running on multiple server computers 110.

The map service 193 may be, for example, a web server 163 or web service that provides maps of geographic areas. Yahoo!® Maps, a web site that provides maps that display roads and other geographic features, is an example of the map service 193. The maps may be displayed on the display by the web browser 106. The maps provided by the map service 193 are referred to herein as map bases 102 because they may be displayed as bases upon which additional semi-transparent (i.e., partially transparent) map layers 100 are overlaid to produce a composite map to be shown on the display 190.

Client components executing on the client 146 computer in conjunction with the web browser 106 interact with server components executing on the server computer 110 to provide for creation, configuration, and display of map layers 100 on the map bases 102. Each layer 110 may be associated with an image 128, e.g., a picture in a defined graphical data format such as GIF or JPEG, annotations 166 such as text labels associated with specific locations on the image 128, and geometry parameters 108 that specifies a position 118, scale 122, and orientation 124 of the layer or image 128. A layer 110 may also be associated with lines or other arbitrary geometric shapes, or three-dimensional objects to be displayed on the display 190. These shapes or objects may, for example, represent the appearance buildings on a map.

In one example, the client components are executed by or invoked by a web browser 106 and include map base presentation logic 150, layer contribution user interface logic 104, and layer discovery user interface logic 136. The map base presentation logic 150 displays the map base 102 on the display 190 using techniques known to those skilled in the art. For example, the map base presentation logic 150 may display a graphical representation of the map base 102 by displaying a static image of the map base 102 embedded on a web page, or may use client-side code (e.g., JavaScript™) to display portions of images or image tiles that represent portions or regions of the map base 102. The images or tiles of the map base 102 are received from the map service 193 via the network 112.

The layer contribution user interface logic 104 interacts with a user to receive a map layer 100 by presenting a layer contribution user interface that allows the user to define a map layer 100 by providing an image 128 and associated information, such as position 118, orientation 124, and scale factor 126 for displaying the image 128 on the map layer 100 as a semi-transparent overlay. The layer contribution user interface logic 104 transmits that definition of the map layer 100, e.g., the image 128 and associated information, to the server 110 computer, which stores the definition for later use by users browsing or searching the map base 102.

In one example, the layer discovery user interface logic 136 interacts with a user to locate and display previously-defined map layers 100. The layer discovery user interface logic 136 may receive a name of a desired location 140 or a search query. The search query is typically related to the name or description of a desired location 140. For example, a name of a desired location 140 may be “Eiffel Tower” and a search query may be “Paris monuments.” Other types of searches are possible as well. The desired location 140 or query received from the user is referred to herein for simplicity as a “location”, although the location may be a query or other search string 174 that implicitly or indirectly corresponds to a location. The layer discovery user interface logic 136 transmits the desired location 140 to layer discovery logic 182 on the server 110 computer via the network 112. The layer discovery logic 182 performs a search to locate one or more map layers 100 that correspond to the location. In one example, such a correspondence may be established by similarities or relationships between the text description of a map layer 100 and the text in the location query. The layer discovery logic 182 may therefore search the descriptions of the layers in the layers database 130 for layers that have descriptions that match the given location, and may then return each matching layer to the layer discovery user interface logic 136 via the network 112. In one example, the layer discovery user interface logic 136 displays a list of matching layers, from which the user can select a layer to display over the map base 102. In another example, the layer discovery user interface logic 136 displays one or more of the matching layers over the map upon receipt of the matching layers, without waiting for the user to select a layer. In one example, the layer discovery user interface logic 136 may display the map layer 100, e.g., by displaying the layer's image 128 or tile(s) 132 and associated annotations 166 according to the associated geometry parameters 108, where the image 128 is displayed in a semi-transparent manner, using, for example, alpha blending to blend the layer image 128 with the displayed map base 102. The position 118 determines the location on the map base 102 on which the image 128 will be displayed, the scale factor 126 determines the size of the displayed image 128, and the orientation 124 parameter determines the angle or rotation at which the image 128 will be displayed. The display of the layer image 128 and the blending of the layer image 128 with the map base may be done by computer program code, e.g., JavaScript® or the like, implemented in the layer discovery user interface logic 136.

In one example, the browser-based client components are implemented as computer-executable code generated from programming language code (e.g., JavaScript™ code, or code written in any other compiled or interpreted programming language), and may be provided by a component that executes on the server 110. For example, the client 146 components may be downloaded by the browser from the web server 163 via the network 112. The server-based components, such as the layer contribution logic 160, may also be implemented as computer-executable code.

In one example, the layers database 130 is a table in a relational database, e.g., Oracle™, MySQL™, or the like. Each row in the layers database 130 represents a map layer 100.

One or more images 128 may be associated with a layer. For each image 128, geometry information is stored in the layers database 130. The geometry information includes a location, which may be represented by X and Y coordinates or a latitude and longitude, a scale 126 factor, which may be represented as a decimal value, and an orientation 124, which may be represented as a decimal number of degrees. The description associated with a layer may be a string of characters. The image 128 may be stored as a binary object, or as a tile identifier that refers to entries in a tiles database 170, or both an image 128 and a tile identifier. A layer may thus be represented by the values (X, Y, scale 126, orientation 124, description, image 128, where the image 128 may be omitted if the image 128 is stored in a separate table (as described below). A height and a width of the layer may also be included in the layer's representation. The height and the width may be in standard units, such as miles or kilometers. Each layer image 128 may be displayed at multiple zoom levels, e.g., 2×, 3×, and so on. To improve efficiency, the image 128 for each zoom level may be pre-computed and stored in the layers database 130 (or database table). For example, if zoom levels are to be made available, then three images 128 may be stored in each layer row, one image 128 for each zoom level. Alternatively, the images 128 may be stored in a separate table, e.g., an images table, that is related to the layers table by a layer identifier, where the layer identifier is a unique value for each layer that identifies the row that correspond to the layer in each table that stores data for the layer.

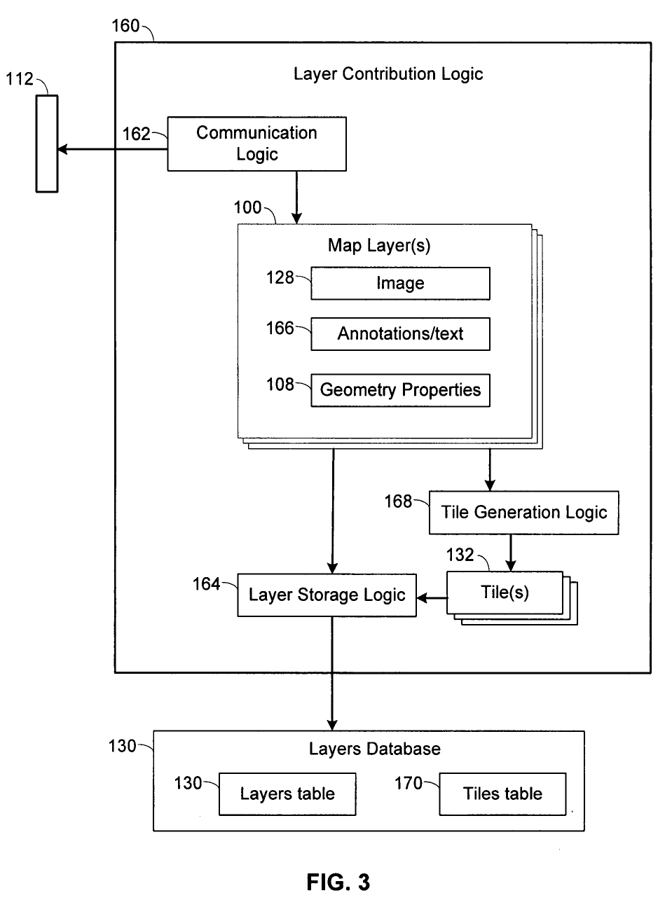

As another alternative approach for storing the images 128, an image 128 may be divided into tiles 132 to reduce the quantity of data transferred when the layer 100 is transmitted across the network. Each tile 132 corresponds to a portion 186 of the image 128, such as a square tile produced by dividing the image 128 with horizontal and vertical lines. When the layer is displayed by the layer discovery user interface 136 logic, a subset of the tiles 132 that corresponds to portions of the layer that will actually be visible on the display need be transmitted by the layer discovery logic 182 to the layer discovery user interface logic 136. The tiles 132 for each zoom level may be pre-computed and stored in the tiles table 170 (shown in FIG. 3 and described below) or in a separate table as described above. In the example described here, each tile is stored as a single row in the tiles database 170, and tile images 128 are stored in each row, one image 128 for each of zoom levels (e.g., 1×, 2× and 3×).

An example layers database 130 would have the following structure:

| Layer_id | X | Y | Scale | Orientation | Description | Height | Width | Image |
|---|---|---|---|---|---|---|---|---|
| 1 | 44.12 | 38.61 | 4.2 | 3.1 | TransitMap | 10 | 20 | Null |
| 2 | 44.17 | 38.60 | 2.4 | 0 | Parks | 5.53 | 1.2 | [binary] |
| 3 | 44.14 | 38.59 | 1.1 | 3.65 | Hiking | 4.9 | 6.8 | [binary] |

In the layers database 130 table shown above, each layer is associated with a layer_id, i.e., a layer identifier, which is a numeric value that uniquely identifies the layer represented by the row in which the layer_id appears.

A tile may be represented by the values (layer_identifier, X, Y, height, width, image1, image2, image3), where image1, image2, image3 are images 128 of the tiles for three different zoom levels. The X and Y coordinates correspond to the upper left corner of the tile. The X and Y coordinates may represent distances in the same standard units used for the height and width of the layers, or may represent percentages along the corresponding axis of the layer. The height and width vales may be omitted or may be replaced by the X and Y positions of the lower right corner of the tile.

In the example layers table shown above, no image 128 is stored for layer (the image 128 is null), but images 128 are stored for layers and. The image 128 for layer is stored at zoom levels in a tiles table 170 as shown in the example tiles table below. The image 128 has been divided into four tiles, and each tile is stored in a separate row. Each row has a Layer_id value set to the layer identifier of the layer to which the tile corresponds. For each tile, images 128 of the tile at the three zoom levels are stored in the Image1, Image2, and Image3 columns.

| Tile_id | Layer_id | X | Y | Height | Width | Image 1 | Image 2 | Image 3 |
|---|---|---|---|---|---|---|---|---|
| 1 | 1 | 0 | | 5 | 10 | [binary] | [binary] | [binary] |
| 2 | 1 | 5 | | 5 | 10 | [binary] | [binary] | [binary] |
| 3 | 1 | 0 | 10 | 5 | 10 | [binary] | [binary] | [binary] |
| 4 | 1 | 5 | 10 | 5 | 10 | [binary] | [binary] | [binary] |

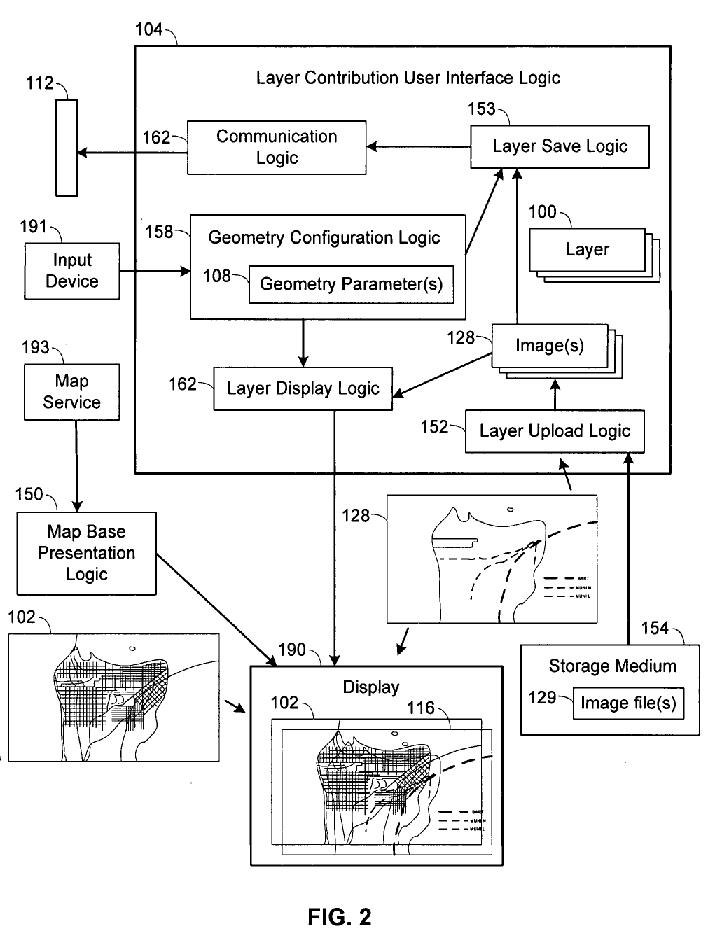

FIG. 2 is an illustrative drawing of layer contribution user interface logic 104 in accordance with embodiments of the invention. As shown in FIG. 1, the layer contribution user interface logic 104 executes on a client 146 in conjunction with a web browser 106, and may receive at least one map layer 100 from, for example, a user. The map layer 100 may be used to annotate or augment a map base 102 with additional information, such as a graphical image 128 and a textual description of a particular location on the map base 102. The layer contribution user interface logic 104 includes layer upload logic 152 for receiving the at least one map layer 100 from a storage medium 154, layer display logic 156 for presenting the at least one map layer 100 for display as a semi-transparent image 128 on the map base 102, geometry configuration logic 158 for positioning the at least one map layer 100 relative to the map base 102 as specified by the geometry parameters 108, and layer save logic 153 for communicating the map layer 100 (s) to a server 110 for storage. The layer upload logic 152 receives at least one image 128 or other media file from the client computer 146. For example, the user may interact with the web browser 106 to select an image file 129 of train stations in Paris for use as a layer. The layer upload logic 152 allows the user to upload the image file 128 from a storage medium 154 on the client computer 146 by reading the file from the computer.

The layer display logic 156 displays the layer 100, including any media objects such as images 128, and any text annotations 166 provided by the user. If the media objects are images 128, the user may configure the geometry, e.g., the position 118, orientation 124, and scale factor 126, of the images 128 by interacting with the geometry configuration logic 158 via an input device such as a mouse or a keyboard. As the user adjusts the geometry of the image 128, the layer display logic 156 updates the display to show the image 128 with the updated geometry. For example, the layer display logic 156 moves, rotates, and scales a semi-transparent image rendition 116 of the image 128. The rendition 116 is shown on the display 190 in response to user commands received from the input device 191. In one example, the semi-transparent image rendition 116 appears visually to be superimposed or blended with the map base 102 and may be displayed, e.g., using browser overlay techniques, over the map base 102. The blending technique may employ, for example, alpha blending to blend the colors of the rendition with the colors of the map base 102 according to an opacity value 144 that specifies the proportion of the rendition 116 to be displayed relative to the proportion of the map base 102 to be displayed. The opacity value 144 is typically a percentage, or a decimal value between “0” and “1”, where “1” corresponds to the rendition 116 being displayed completely, with no transparency, in which case the portion of the map base 102 overlaid by the rendition 116 is not visible. On the other end of the opacity spectrum, the opacity value 144 “0” corresponds to the map base 102 being displayed completely, in which case the portion of the rendition 116 that overlays the map base 102 (for example, the entire rendition 116, since the rendition 116 typically covers a smaller area than the map base 102) is not visible.

The layer 100 may be saved for layer use, e.g., by storing the layer 100 in a layers database 130 for subsequent retrieval. In one example, the user may select a Save command to store the layer 100, including any media objects, e.g., images 128, and annotations 166, the user has defined. The layer save logic 153 prepares or serializes the data structures that represent the layer 100, including the geometry parameters 108, the image 128, and any associated annotations, into a format suitable for transmission on the network 112, e.g., by converting those data structures into a sequence of bytes that can be de-serialized on the server 110 by communication logic 162 or similar logic (e.g., layer receiving logic, not shown) in the layer contribution logic 160 on the server 110, to re-create those data structures. To store the layer, the communication logic 162 sends the byte sequence representation of the layer 100, to the server 110 computer of FIG. 1 via the communication network 112. On the server 110, layer contribution logic 160 receives the layer and stores it in the layers database 130.

In one example, the map base 102 is received from the map service 193. The layer contribution user interface logic 104 may include base presentation logic 150 for presenting the map base 102 for display. Alternatively, the base presentation logic 150 may be external to the layer contribution user interface logic 104, e.g., a component of a web browser 106.

FIG. 3 is an illustrative drawing of layer contribution server logic 160 for annotating geographic maps in accordance with embodiments of the invention. The layer contribution server logic 160 is, for example, computer program code that executes on a computer such as the server 110 of FIG. 1. The layer contribution server logic 160 receives one or more map layers 100 from the layer contribution user interface 104 logic of FIG. 2 via communication logic 162. As described above, each map layer 100 includes an image 128, annotations 166, e.g., textual labels and notes for particular positions on the map, a description of the layer, and geometry properties 108.

The layer contribution logic 160 contains communication logic 162 for communicating with a layer contribution user interface 104 via a computer network 112, wherein the communication logic 162 is able to receive at least one image 128 from the layer contribution user interface 104. The communication logic 162 performs any necessary data serialization of objects such as map layers 100 to and de-serialization from binary data suitable for transmission on the network 112. The communication logic 162 is able to receive geometry parameter(s) 108 and text annotation(s) 166 associated with the image 128 (s) from the layer contribution user interface 104. The geometry parameter(s) specify a location for the image 128 (s) on the map base 102, as described above.

The layer contribution logic 160 also contains layer storage logic 164 for storing the at least one map image 128 in association with the at least one geometry parameter 108 in a layers database 130. The layer storage logic 164 may also store the text annotation (s) 166 in association with the at least one map image 128 in the layers database 130. The layers database 130 may be, for example, a relational database as described above. The layer storage logic 164 may use Structured Query Language (SQL) statements to store and retrieve data in the layers database 130.

In one example. the layer contribution logic 160 may also include tile generation logic 168 for generating tile(s) 132 based upon the map layer(s) 100, where the tile generation logic 168 is may rotate and scale the at least one tile 132 using two-dimensional geometric image transformation methods (such as rotation, scaling, and movement) as specified by the geometry parameter(s) 108, and may store the tile(s) 132 in a tiles database 170. In the tiles database, the at least one tile 132 is associated with the at least one map layer 100, e.g., using a database relation based upon a common numerical value, such as the Layer_id described above. The tile generation logic 168 partitions each map layer 100 into multiple tiles 132 to reduce data transmission and computation time when only a portion 186 of the layer 100 is to be displayed. The tiles 132 create a finer granularity of images 128, so that the entire image 128 need not be sent via the network and displayed. The tiles database 170 stores information about each tile as described above. The number of tiles 132 into which a particular layer will be divided may be controlled by a predetermined parameter, which may specify, for example, that tiles of a certain size (e.g. L feet by W feet) are to be created for a certain zoom level (e.g., 3×).

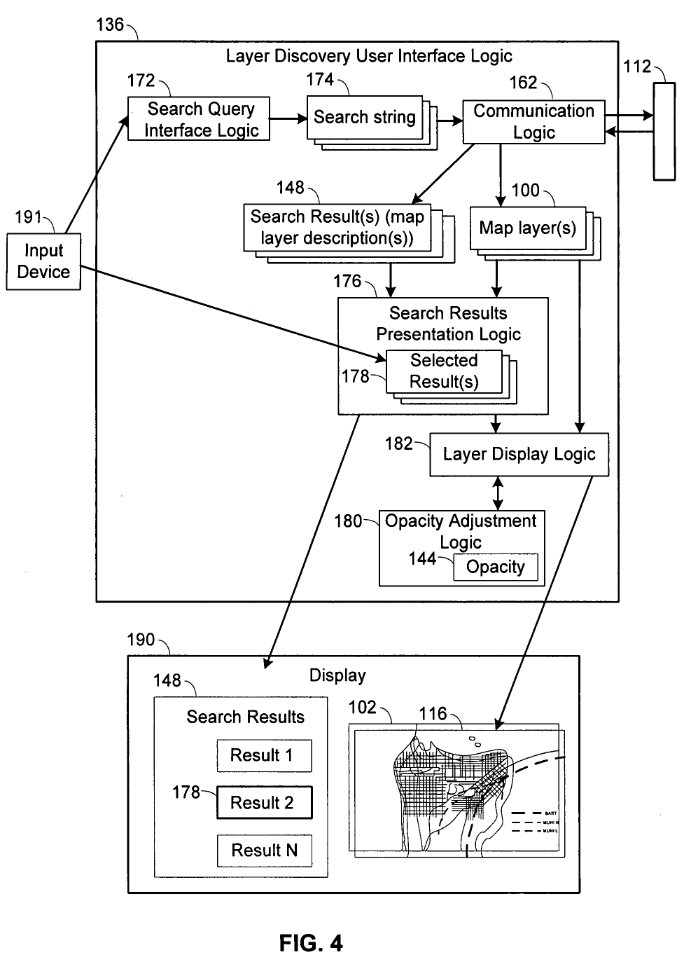

FIG. 4 is an illustrative drawing of layer discovery user interface logic 136 in accordance with embodiments of the invention. The layer discovery user interface 136 logic executes on a client 146 such as the client 146 computer of FIG. 1, may be executed by a web browser 106, and enables searching for and viewing of map layers 100. A user may search for layers, which may have been created by other users, by entering a search query or string that describes a desired location 140. Search query interface logic 172 receives the search string 174 from the user and transmits the string to a server 110 via communication logic 162 and network 112. When the server 110 receives the string, layer discovery logic 182 on the server 110 searches a layers database 130 for matching layers, and returns any matching layers, or descriptions of such matching layers, as search results 148, depending on the closeness of the match to the desired location 140, or upon a particular system configuration. The layer display logic 156 then receives the search results or map layer 100 (or both) from the server 110. For example, in some configurations, the closest matching layer may be returned for immediate display, while in other configurations, a list of matching layers may be returned, so that the user interface logic may subsequently request the details of a particular layer. The user interface logic may also display advertisements related to the search string 174 or related to the search results. Search results presentation logic 176 displays the search results and allows the user to select one or more results, e.g., by clicking on the desired result(s). The selected result 178 (s) are illustrated in FIG. 4 as selected results 178.

As described above, the layer discovery user interface logic 136 may request the layer that corresponds to the selected search result, and may also directly request a layer that corresponds to a location name provided by the user. The layer discovery logic 182 on the server 110 receives the request, searches the layers database 130, and returns the layer(s), including, for example, an image 128 or tile(s), geometry parameters 108, and annotations 166, if present. In one example, related advertisement text or images 128 may also be returned with the layer(s) 100. Layer display logic 156 then displays the selected or returned map layer 100 on the display 190. In one example, the layer 100 is displayed as a semi transparent image rendition 116 that visually appears to be superimposed on the map base 102 (as described above, with reference to FIG. 2) at a location specified by a position coordinates parameter 118 associated with the map layer 100.

Opacity adjustment logic 180 allows a user to adjust an opacity value 144 of the semi-transparent image rendition 116. The opacity value 144 controls the proportion of the rendition 116 of the layer that is displayed relative to the base 102, as described above with reference to FIG. 2.

The layer display logic 156 displays the layer(s) 100 as specified by geometry parameter(s) 108 associated with the layer(s) 100. The position 118, scale (i.e., size) 122, and orientation 124 of the map layer 100 are based upon the geometry parameter(s) 108 associated with the map layer 100. If the user repositions the displayed map base 102, e.g., by viewing a different location on the map, the appropriate image or tile(s) of any displayed layers are requested from the server 110 and displayed on the display 190.

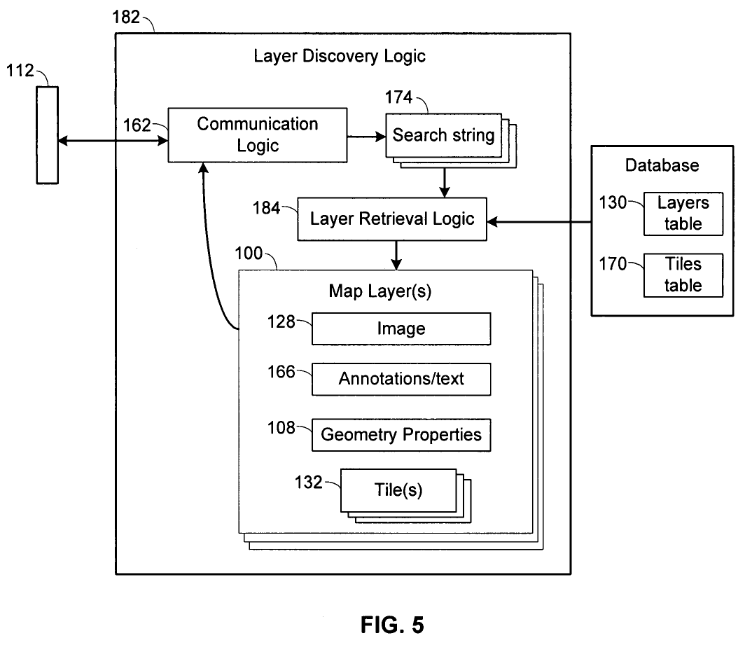

FIG. 5 is an illustrative drawing of layer discovery server logic 182 in accordance with embodiments of the invention. The layer discovery logic 182 retrieves layers requested by the layer discovery user interface logic 136. The layer(s) 100 to be retrieved are specified by a search query string 174, e.g., “Paris monuments” or “Eiffel tower.”

Communication logic 162 receives at least one request that explicitly (e.g., “Eiffel tower”) or implicitly (e.g., “Paris monuments”) specifies the desired map layer 100 (s) from a layer discovery user interface 136 via a computer network 112. Layer retrieval logic 184 attempts to retrieve at least one matching or related map layer 100 from a layers database 130 using, for example, an SQL query that searches the layers database 130 for layers whose descriptions match the query string 174, by e.g., selecting rows from the layers table for which the description column matches or is related to the query string 174. The query may also search for layers whose tags match the query string. In one example, tags are a form of textual annotation that users may associate with map layers. The results of the query may include more than one layer, in which case the layers may be sorted by a “popularity” that may include tags, number of page views, or thumbs up or down ratings.

As an example of retrieving related layers, the layer retrieval logic 184 may retrieve layers that are geographically near a layer 100 that matches the search string 174. Such nearby layers may be layers that have a position 118 (i.e., x, y coordinates) within a certain distance of the position 118 of a layer whose description matches the query string 174. The communication logic 162 then transmits the matching or related map layer 100 (s) to the layer discovery user interface 136 via the computer network 112.

The layer retrieval logic 184 may retrieve at least one tile 132 associated with the at least one map layer 100 from a tiles database 170 using, for example, the relation established between the layers table 130 and the tiles table 170 by the layer identifier. The tiles 132 may be selected based upon, for example, dimensions of a visible portion 186 of the map base 102 displayed on the client 146 and the current zoom level at the client 146. Tiles 132 that are not visible need not be retrieved and sent to the client 146. The visible tiles 132 of the appropriate zoom level (and possibly other tiles) are sent to the layer discovery user interface 136 via the computer network 112 as part of the layer(s) 100.

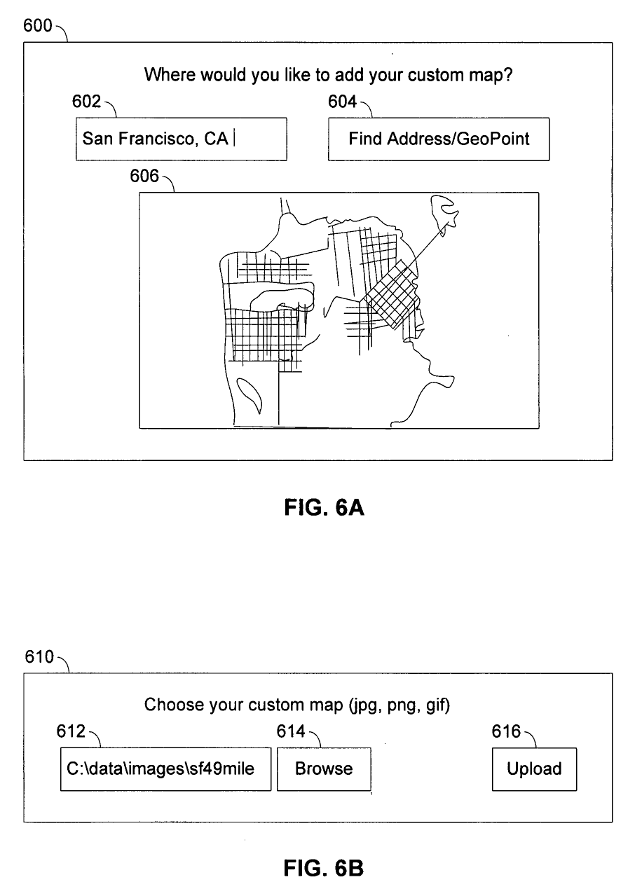

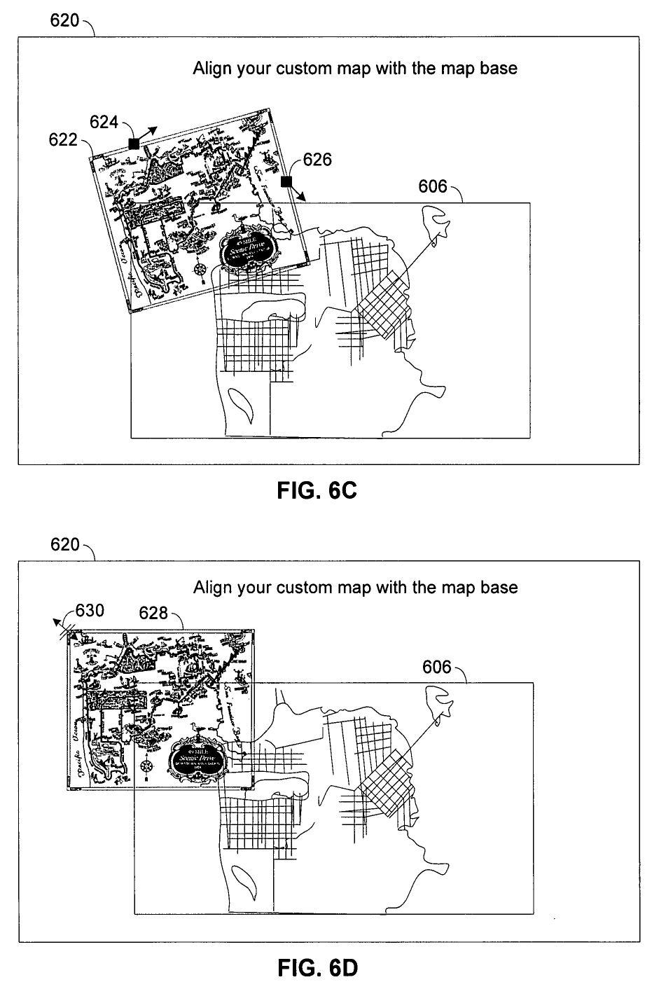

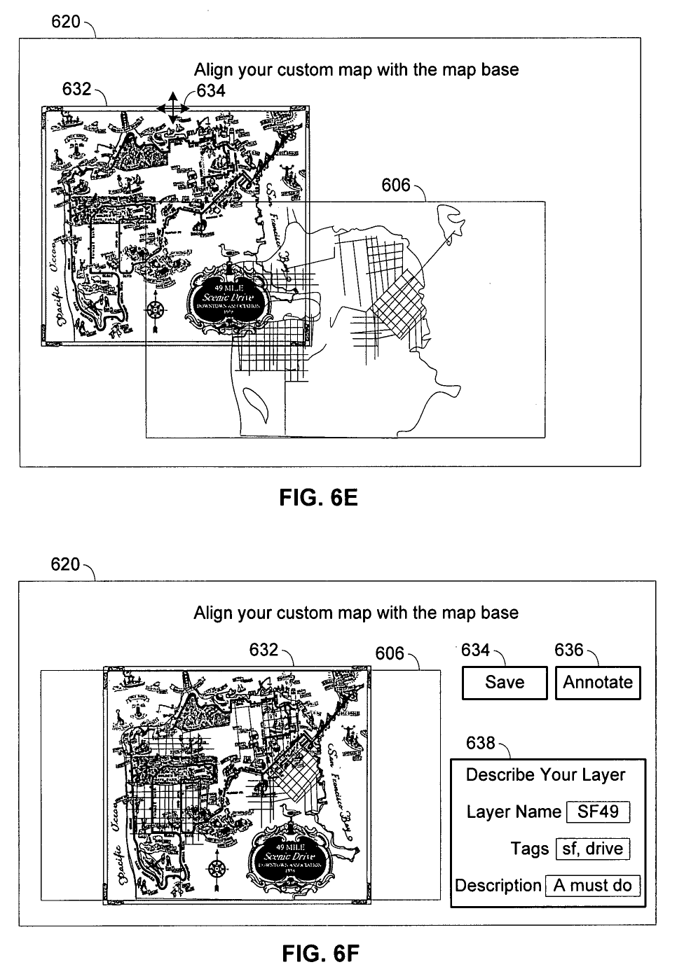

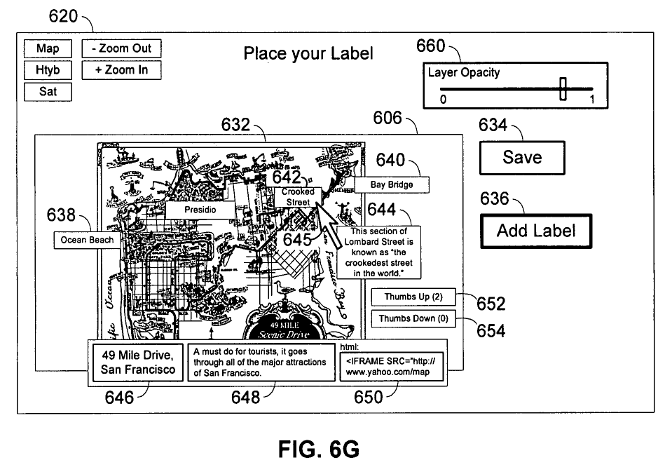

FIGS. 6A-6G are illustrative drawings of layer contribution user interfaces 610, 620 in accordance with embodiments of the invention. The layer contribution user interfaces 610, 620 may be generated by the layer contribution user interface logic 104 of FIG. 1. FIG. 6A shows an exemplary initial screen presented by the layer contribution user interface 104 of FIG. 1. A map base 606 is displayed by the map base presentation logic 150. A user may select a location on the map base 102 by entering a location name in a location input field 602 and clicking a mouse input device or selecting a Find Address button 604. The user may also select a location by scrolling the map base 606 and clicking a displayed point on the base 606.

Once the user has selected a location, a layer upload user interface 610 allows the user to provide a custom map or image 128 for the new layer. The location of an image file 129 may be provided in a file input box 612. The user may select a browse button 614 to browse for files on the client computer 146. Once a file has been selected, the user may select an upload button to cause the layer upload logic 152 to retrieve the file from the storage medium 154. The image file 129 may be, for example, a GIF file, a JPEG file, a PDF file a KML (XML format geographic data file that may describe the image overlay and provide an image URL), or the like. The layer contribution user interface logic 104 will then allow the user to configure the geometry of the image 128 relative to the map base 606.

FIG. 6C illustrates an exemplary geometry configuration user interface 620 which allows a user to align the custom map image 622 with the map base 606. The user may rotate the image 622 by using a pointer input device, e.g., a mouse, to select and drag rotation control(s) 624, 626. FIG. 6D illustrates the effect of rotating the image 622 to produce a rotated image 628, which has been rotated by the user by approximately 20 degrees clockwise to match the angle of the base map 606. The user may then resize the image 628 using a resize control 630. The user may enlarge the image 628 by dragging the resize control 630 away from the image 628, or may reduce the image's size by dragging the resize control 630 toward the center of the image 628. FIG. 6E shows the result of enlarging the image 628 to produce a larger image 632. The user may then position the image 632 by clicking on a position control 634 (or by clicking on the image 632 and dragging the mouse to position the image 632 at the desired location shown in FIG. 6F. In this example, the user moves the image 632 to the right and downward to position the image over the map base 606 so that the geographical map features of the image 632 are aligned with, e.g., in substantially the same X and Y location as, the features of the map base 606. FIG. 6F shows the result of positioning the image 632. In one example, the image 128 is displayed with partial transparency, so that visual features of the base map 606, e.g., streets and landmarks, remain visible. The layer contribution user interface 620 allows the user to save the image 632 as a new layer by clicking a Save button 634, in which case the image 632 and geometry parameters that describe the location and any rotation or scaling that was performed will be transmitted via communication logic 162 to the layer contribution logic 160 for storage and subsequent retrieval by the layer discovery logic 182. The user may also associate text annotations 166 or labels with the image 632 by selecting an Annotate button 636. The user may annotate the image 632 itself by specifying a name, tags, and a description by entering information in description input fields. The description and annotations 166 will be sent to the layer contribution logic 160 along with the image 632.

FIG. 6G illustrates user interface features for adding and displaying text annotation labels to a map layer 632 in accordance with embodiments of the invention. A semi-transparent image rendition of a map layer 632 is displayed superimposed on a map base 606. A layer name 646, “Mile Drive” and a layer description 648 have been supplied by the user and are displayed below the image 128. Labels 638 (“Ocean Beach”), 642 (“Crooked Street”), and 640 (“Bay Bridge”) have been created by the user and placed in associated positions on the layer 632. Descriptive text may be associated with a label, as shown by the text 644 that appears when a mouse pointer 645 is positioned over the associated label 642. A Save button 634 allows the user to save the labels and descriptions as part of the layer 632. An Add Label button 636 allows the user to add additional labels. Labels may be defined in the layer contribution user interface 620 and in the layer discovery user interface 136. A label may describe a two-dimensional region on a map or layer, or may describe a single point. The region may be a rectangle or a polygon of arbitrary shape specified by a list of points.

Users may provide ratings for a map layers 632 when the map layers 632 is being viewed, e.g., when the map layer 632 is displayed in the layer discovery user interface 136. To provide a positive rating, a user selects or clicks a Thumbs Up indicator 652. Similarly, to provide a negative rating, a user selects a Thumbs Down indicator 654. The results of the user ratings process may be displayed along with the map layer 100. In this example, the Thumbs Up indicator 652 displays a number “2” in parentheses to indicate that two users have provided positive ratings, and the Thumbs Down indicator 654 displays a number “0” to indicate that no users have provided negative ratings of the layer 632.

In one example, a layer opacity control 660 allows a user to change the opacity value 144 that controls the proportion of the map layer 632 that is displayed relative to the map base 606. The opacity control 660 in this example is a slider control that can be adjusted to select a value between “0” (e.g., the layer 632 is not displayed) and “1” (e.g., the layer 632 is displayed as opaque, with no transparency, so that the map base 606 is not displayed). The degree of transparency of the displayed map layer 632 may be adjusted in response to the user's adjustment of the opacity control 660. For example, movement of the control 660 by one increment may result in the display being updated to show an adjustment of the degree of transparency of the layer 632.

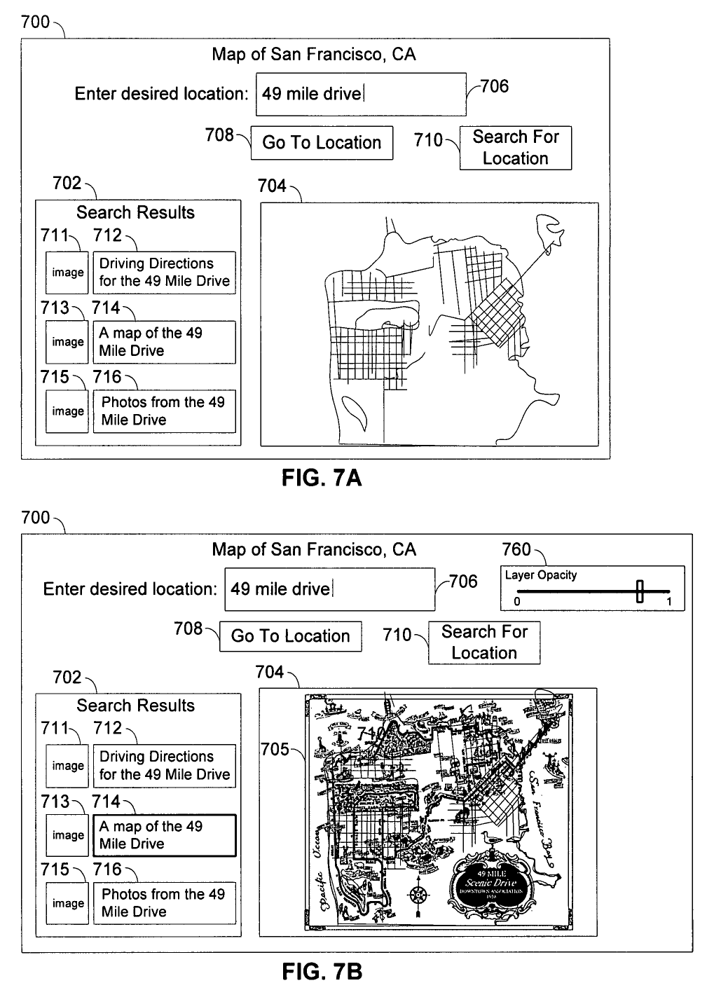

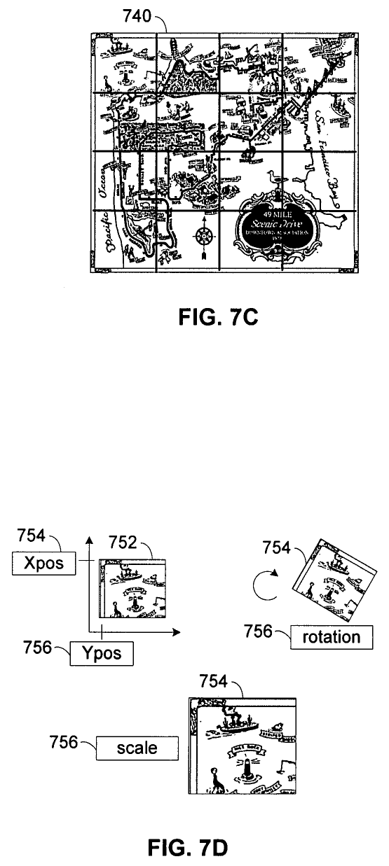

FIGS. 7A and 7B are illustrative drawings of layer discovery user interfaces 700 in accordance with embodiments of the invention. The layer discovery user interfaces 700 may be generated by the layer discovery user interface logic 136 of FIG. 1. FIG. 7A shows an exemplary layer discovery user interface 700 that allows a user to provide a desired location 706. A map base 704, which may be a map of the desired location or of a previously-viewed location, is also displayed. The user may select a Go To Location button 708 to cause a request for a specific location (e.g., San Francisco, Calif.) to be sent to the layer discovery logic 182. If the desired location 706 is found, a layer 705 will be returned and displayed in the user interface 700 as shown in FIG. 7B. The user may specify the desired location 706 by entering the name of the desired location or a search string, e.g., “mile drive” in the input box 706, and selecting a Search for Location button 710. The search string will be sent to the layer discovery logic 182, which will search the layers database 130 and, if any matches are found, return a map layer 705 or a list of search results 702. The map layer 705 or search results 702 may then be displayed in the layer discovery user interface 700. The map layer 705 may be displayed as a semi-transparent overlay, and an opacity control similar to the opacity control of FIG. 6G may be provided in the layer discovery user interface 700.

The search results display 702 shows each search result as an optional image 711 and a description 712 that correspond to the map layer represented by that search result. The image 711 is, for example, a small icon or thumbnail view of the map layer image, and the description 712 is the description of the layer (or a portion of the description). Three search results 712, 714, 716 are shown in FIG. 7B, but any number of search results may be displayed (using a slider if necessary to include non-displayed search results in the list).

FIG. 7C is an illustrative drawing of layer tiles in accordance with embodiments of the invention. A map layer 740 has been partitioned into 16 tiles. The partition lines are shown for illustrative purposes and are not typically shown in a user interface. As described above with respect to FIG. 3, the tile generation logic 168 may optionally partition each map layer 100 into multiple tiles to reduce data transmission and computation time when a portion of the layer 100, i.e., a subset of the tiles, is to be displayed.

FIG. 7D is an illustrative drawing of layer geometry transformations in accordance with embodiments of the invention. A position transformation on a layer 762 adjusts the x component of the position 754 or the Y component 756, or both, of the layer. The position transformation is therefore represented by the X, and Y coordinates, which may be associated with the layer as geometry parameters 108. A rotation transformation rotates a layer 754 by a rotation value 756, e.g., an angular value in degrees. The angular value 756 is a geometry parameter that may be associated with the layer 754. A scale transformation enlarges or reduces the size of a layer 754 by a scale factor 756. For example, a positive numeric scale value 756 enlarges the layer, and negative scale value 756 reduces the displayed size of the layer 754.

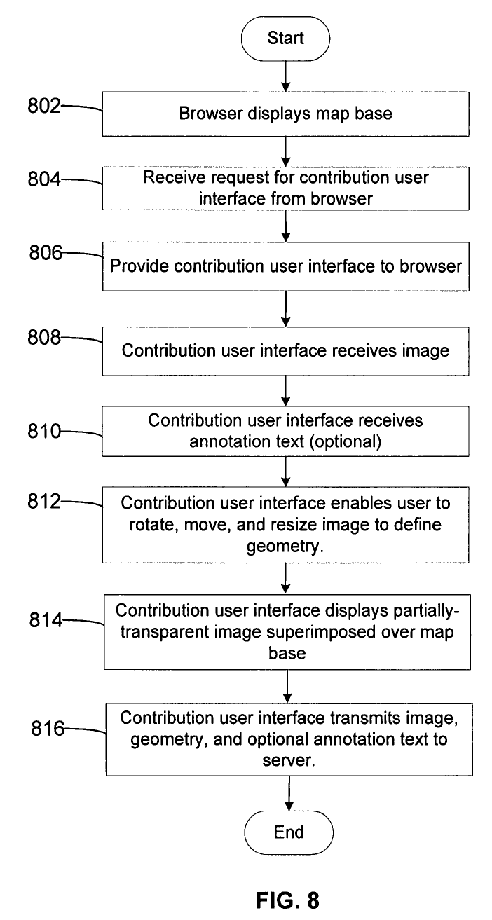

FIG. 8 is an illustrative drawing of a layer contribution user interface process in accordance with embodiments of the invention. The process of FIG. 8 is a computer enabled method of enabling contribution of a map layer 100 to annotate a map base 102. The process of FIG. 8 is similar to the layer contribution user interface logic 104 of FIG. 1. The process may be executed on a server 110 to provide a user interface to a client 146. In one example, the user interface is capable of performing the steps of blocks 808-816.

At block 802, map base presentation interface logic 150 displays the map base 102. Block 804 receives a request from a browser 106 to open a contribution user interface such as the interface 620. The request may be, for example, a request for a URL that corresponds to a web page that includes a contribution user interface. The user may select the URL for the contribution user interface from the map base presentation interface 150.

Block 806 provides the contribution user interface 104 for receiving and configuring a map layer 100 on a web browser 106. For example, block 806 may transmit the contribution user interface 104 (e.g., a web page or script code) over a communications network 112. At block 808, the user provides a media object for the new layer, such as an image of a custom map or an image of details of a location, and uploads the media object to the contribution user interface. At block 810, the user may provide annotations 166, such as labels, descriptions, tags, or a name for the new layer.

At block 812, the contribution user interface 104 may receive geometry parameter(s) 108 for the map layer 100 from a user or input source via the web browser 106. For example, the user may rotate, move, and scale the image 128 using user interface controls in the web browser 106. The user interface 104 may derive the geometry parameters 108 from the user interface components that the users uses to rotate, scale, and move the image 128. The geometry parameter(s) 108 may include a position coordinates parameter 118, a layer dimensions parameter 120, a layer orientation parameter 122, or a combination of those.

At block 814, the contribution user interface 104 presents for display a semi-transparent image rendition 116 of the map layer 100. The partially transparent image rendition 116 is, in one example, an image 128 superimposed over the map base 102, and the semi-transparent image rendition 116 is based upon the geometry parameter(s) 108. The location of the semi-transparent image rendition 116 on the map base 102 may be based upon the position coordinates parameter 118. The size, e.g., height and width in pixels, of the semi-transparent rendition 116 may be based upon the layer dimensions parameter 120. The orientation 124 of the semi-transparent rendition 116 may be based upon the layer orientation parameter 122. Block 816 transmits the image 128, geometry 108, any optional annotation text 166, description text, or labels received from the user to the server 110. The server 110 stores the map layer 100, the geometry 108, and annotations 166 in a layers database 130. At block 816, the contribution user interface 104 transmits the map layer 100 and geometry 108 to a server 110 over a computer network 112 to contribute the map layer 100.

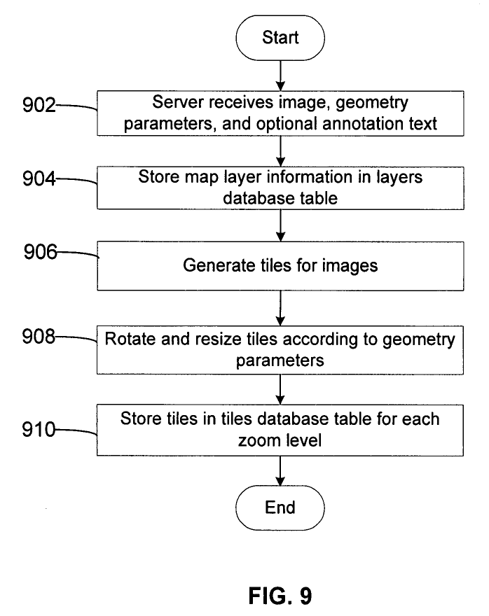

FIG. 9 is an illustrative drawing of a layer contribution server-side process in accordance with embodiments of the invention. In one example, the process is a computer-enabled method of maintaining a layers database 130, and the process executes on a server 110. The process of FIG. 9 is similar to the layer contribution logic 160 of FIG. 1. Block 902 receives an image 128 from a web browser 106 via a computer network 112. Block 902 also receives at least one geometry parameter 108 associated with the image 128 from the web browser 106 via the computer network 112. Block 904 stores the geometry parameter(s) in the layers database 130. Block 904 may store the image 128 in the layers database 130 as well. If tiles will be generated (at block 906), then block 904 may still store the image 128 to allow the user to edit layers, or to allow the tiles to be regenerated, for example, in response to a change in the tile representation or granularity.

Block 906 generates at least one tile 132 by partitioning the image 128 as described above with respect to FIG. 3. A scale 126 and an orientation 124 of the tile are 132 based upon the at least one geometry parameter 108 and upon tile configuration such as the preferred or maximum size of each tile. Block 908 may perform geometric transformations such as rotation and resizing of the tiles 132 as necessary to prepare the tiles 132 for display in accordance with the geometry parameter(s) 108 of the layer 100. Block 910 stores the tile 132 in the layers database 130. Block 910 may also store multiple renditions of the tile at different zoom levels that correspond to different scales 126 at which a user may view the layer.

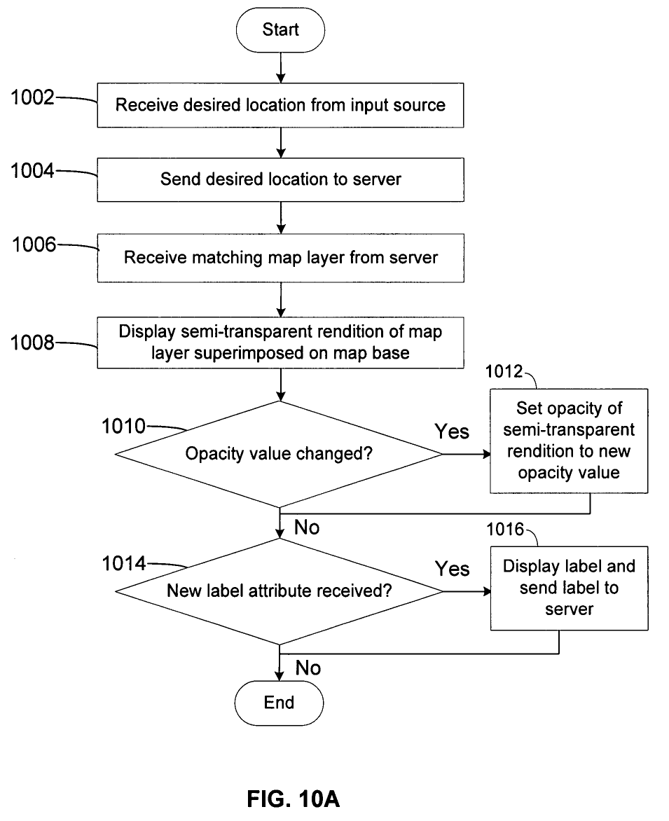

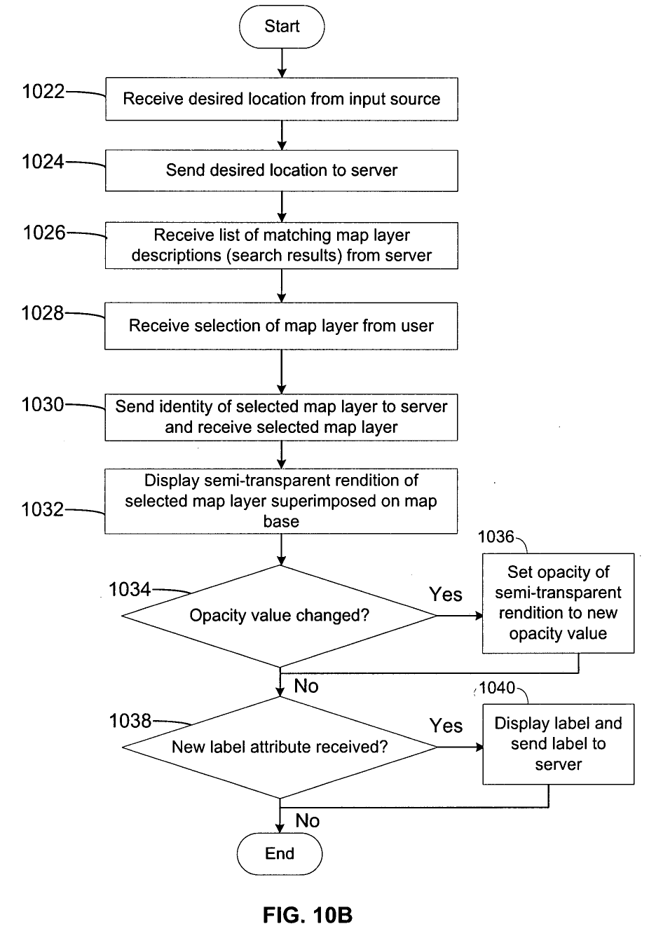

FIG. 10A is an illustrative drawing of a layer discovery user interface 136 process in accordance with embodiments of the invention. In one example, the process is a computer enabled method of enabling discovery of a map layer 100. The process of FIG. 10A is similar to the layer discovery user interface logic 136 of FIG. 1. A server 110 may provide computer program code for executing the process to a client 146 such as a web browser 106. In one example, the user interface is capable of performing the steps of blocks 1002-1016.

The process of FIG. 10A provides a map base presentation interface such as the interface 704 of FIG. 7, for presenting a map base 102 in a web browser 106. The process also provides a layer discovery user interface 136 for discovering at least one map layer 100 via a web browser 106, where the map layer 100 is associated with the map location on the map base 102. Block 1002 receives a desired location 140 via the user interface (e.g., web browser 106. Block 1004 sends the desired location 140 to a server 110. Block 1006 receives one or more matching map layers 100 from the server 110. The matching map layer 100 (s) are associated with the desired location 140, e.g., by a description that matches the desired location 140, or by being geographically near the desired location 140.

At block 1008, the layer discovery user interface 136 displays the map layer 100 as a semi-transparent rendition 116 superimposed on at least a portion of the map base 102. The portion of the map base 102 overlaid by the map layer 100 is defined by at least one geometry parameter 108 associated with the map layer 100.

If the map layer 100 is associated with at least one tile 132, then block 1008 displays the tile(s) 132 that are in the displayed or visible region of the map base 102. The tiles are displayed as semi-transparent overlays 116 superimposed on the map base 102. The location at which a tile 132 is displayed is defined by geometry parameter(s) 108 associated with the tile 132. As described above, when the semi-transparent image rendition of the map layer 100 or tile is displayed, the portion of the map base 102 overlaid by the map layer 100 is at least partially visible, and the transparency of the map layer 100 is based an opacity value 144. Blocks 1010 and 1012 respond to a user's adjustment of the opacity (using, for example, the opacity control of FIG. 6G). Block 1010 determines if the opacity value 144 has changed (i.e., the slider has been moved). If so, block 1012 changes the opacity of the semi-transparent image rendition of the layer by, for example, adjusting the alpha-blending setting used to display the layer.

Blocks 1014 and 1016 respond to a user's contribution of a new label attribute to a layer. Block 1014 determines if the user has submitted a new label. A user may submit a label by selecting the Add Label button 636 of FIG. 6G. If a new label has been received, block 1016 displays the label on the map layer 100 and sends the label text and geometry to the layer contribution logic 160.

FIG. 10B is an illustrative drawing of a layer discovery user interface 136 process in accordance with embodiments of the invention. The process of FIG. 10B is similar to that of FIG. 10A, with the additional provision of a result set of matching layers. When multiple layers match a desired location 140 or search query, a set or list of the matching layers may be returned to the client 146 and displayed as a result set. The user may select one of the results from the set, and the client 146 will request, receive, and display the selected result 178. Block 1022 receives the desired location 140 (e.g., “mile drive”), block 1024 sends the desired location 140 to the layer discovery logic 182, and block 1026 receives a result set that contains descriptions of layers that match the desired location 140. Optionally, one or more of the layers (including the images and annotations) may also be received at block 1026. A user then selects one of the layer descriptions from the result set, and block 1028 receives the selection. Block 1030 sends the description or identity of the selected layer to the layer discovery logic 182 and receives the selected map layer (if the selected map layer has not already been received). Block 1032-1040 display the layer and allow for opacity changes and addition of labels as described above with respect to FIG. 10A.

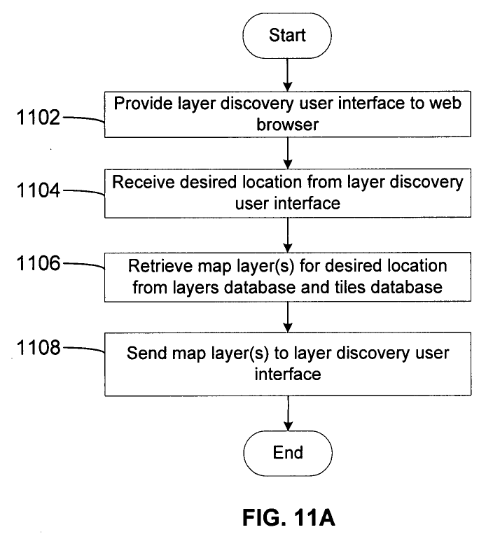

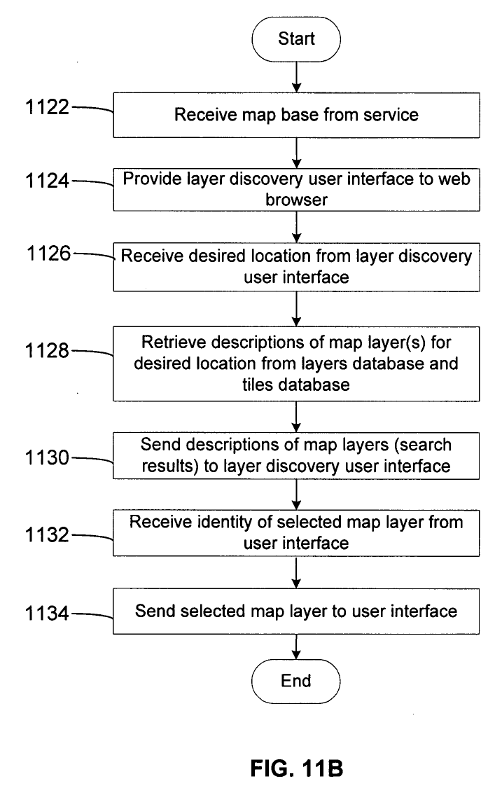

FIG. 11A is an illustrative drawing of a layer discovery server-side process in accordance with embodiments of the invention. In one example, FIG. 11A is a computer-enabled method of providing map layers 100. The process of FIG. 11A is similar to the layer discovery logic 182 of FIG. 1. The process may be invoked by a web server 163 in response to a request from a web browser 106, e.g., selection of a URL (Uniform Resource Locator) from a web page that displays a map base 102 provided by a map service. Block 1102 provides a layer discovery user interface 136 to a web browser 106 by, for example, transmitting the layer discovery user interface 136 (e.g., a web page or browser-executable script code) over a communications network 112. In other examples, the layer discovery user interface 136 may have been previously provided to the web browser 106 and need not be provided for each invocation of the layer discovery process of FIG. 11A. Block 1104 receives via the computer network 112 a desired location 140 from the layer discovery user interface 136 that executes on the client 146.

Block 1106 retrieves a map layer 100 that corresponds to the desired location 140 from a layers database 130. If the map layer 100 references tiles, block 1106 retrieves the appropriate (e.g., visible) tiles as part of the map layer 100. In one example, block 1106 uses a database query (e.g., a SQL query) to select the at least one map layer 100 from the layers database 130 using the name or description of the desired location 140 as search criteria, or using the distance of the map layer 100 from the desired location 140 as search criteria. Block 1108 sends the at least one map layer 100 retrieved in block 1106 to the layer discovery user interface 136.

FIG. 11B is an illustrative drawing of a layer discovery a layer discovery server-side process in accordance with embodiments of the invention. The process of FIG. 11B is similar to that of FIG. 11A, with the additional provision of a result set of matching layers as described above with reference to FIG. 10B. The process of FIG. 11B retrieves from the layers database 130 descriptions or names of map layers 100 that match the desired location 140, without necessarily retrieving the other layer information such as the image 128. Block 1130 sends these descriptions or names to the layer discovery user interface 136 as a result set. Block 1132 receives a name or other identifier for a selected layer from the layer discovery user interface 136. Block 1134 sends the information for displaying the selected layer, such as an image 128 or tiles 132, and annotations 166, to the layer discovery user interface 136.

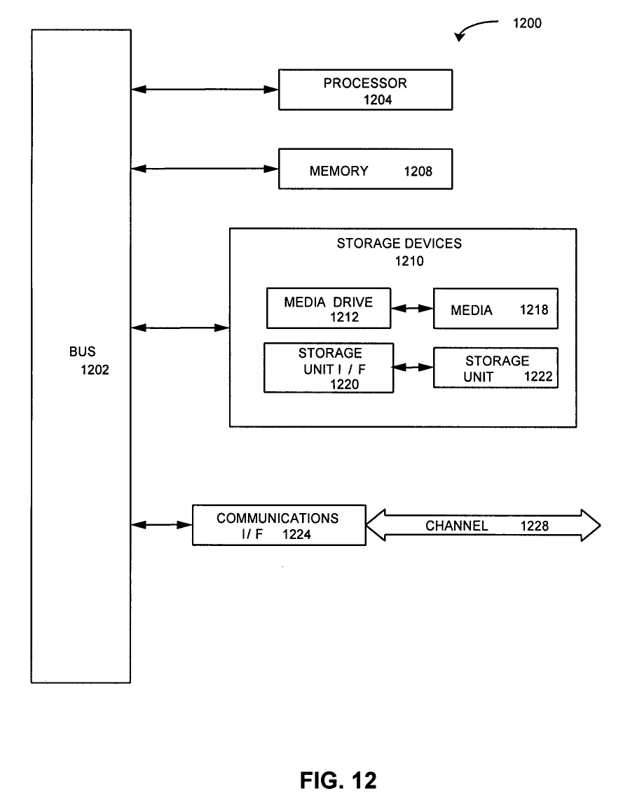

FIG. 12 is an illustrative drawing of an exemplary computer system that may be used in accordance with some embodiments of the invention. FIG. 12 illustrates a typical computing system 1200 that may be employed to implement processing functionality in embodiments of the invention. Computing systems of this type may be used in clients and servers, for example. Those skilled in the relevant art will also recognize how to implement the invention using other computer systems or architectures. Computing system 1200 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 1200 can include one or more processors, such as a processor 1204. Processor 1204 can be implemented using a general or special purpose processing engine such as, for example, a microprocessor, microcontroller or other control logic. In this example, processor 1204 is connected to a bus 1202 or other communication medium.

Computing system 1200 can also include a main memory 1208, such as random access memory (RAM) or other dynamic memory, for storing information and instructions to be executed by processor 1204. Main memory 1208 also may be used for storing temporary variables or other intermediate information during execution of instructions to be executed by processor 1204. Computing system 1200 may likewise include a read only memory (“ROM”) or other static storage device coupled to bus 1202 for storing static information and instructions for processor 1204.

The computing system 1200 may also include information storage system 1210, which may include, for example, a media drive 1212 and a removable storage interface 1220. The media drive 1212 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 1218 may include, for example, a hard disk, floppy disk, magnetic tape, optical disk, CD or DVD, or other fixed or removable medium that is read by and written to by media drive 1214. As these examples illustrate, the storage media 1218 may include a computer-readable storage medium having stored therein particular computer software or data.

In alternative embodiments, information storage system 1210 may include other similar components for allowing computer programs or other instructions or data to be loaded into computing system 1200. Such components may include, for example, a removable storage unit 1222 and an interface 1220, such as a program cartridge and cartridge interface, a removable memory (for example, a flash memory or other removable memory module) and memory slot, and other removable storage units 1222 and interfaces 1220 that allow software and data to be transferred from the removable storage unit 1218 to computing system 1200.

Computing system 1200 can also include a communications interface 1224. Communications interface 1224 can be used to allow software and data to be transferred between computing system 1200 and external devices. Examples of communications interface 1224 can include a modem, a network interface (such as an Ethernet or other NIC card), a communications port (such as for example, a USB port), a PCMCIA slot and card, etc. Software and data transferred via communications interface 1224 are in the form of signals which can be electronic, electromagnetic, optical or other signals capable of being received by communications interface 1224. These signals are provided to communications interface 1224 via a channel 1228. This channel 1228 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 1208, storage device 1218, or storage unit 1222. These and other forms of computer-readable media may be involved in storing one or more instructions for use by processor 1204, to cause the processor to perform specified operations. Such instructions, generally referred to as “computer program code” (which may be grouped in the form of computer programs or other groupings), when executed, enable the computing system 1200 to perform features or functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 1200 using, for example, removable storage drive 1214, drive 1212 or communications interface 1224. The control logic (in this example, software instructions or computer program code), when executed by the processor 1204, causes the processor 1204 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A computer program product comprising program code for receiving at least one map layer to annotate a map base, the program code comprising:
receiving the at least one map layer;
causing the display of the at least one map layer as a semi-transparent image on the map base;
causing the display of the semi-transparent image in a position relative to the map base in response to receipt of at least one geometry parameter, the semi-transparent image adjusting in response to the at least one geometry parameter; and
communicating the at least one map layer to a server for storage.

2. The computer program product of claim 1 where the computer program product is located at a web browser, and the computer program product is provided by a server to the web browser.

3. A computer program product comprising program code for enabling annotation of a map base, the program code comprising:
receiving at least one image and at least one geometry parameter from a layer contribution user interface via a computer network,
wherein the at least one geometry parameter specifies a location on the map base for the at least one image; and
storing the at least one map image in association with the at least one geometry parameter in a layers database.

4. The computer program product of claim 3, the program code further comprising:
receiving at least one text annotation, wherein the at least one text annotation is associated with the at least one image; and
storing the at least one text annotation in association with the at least one map image in the layers database.

5. The computer program product of claim 3, the program code further comprising:
generating at least one tile based upon the at least one map layer;
rotating and scaling the at least one tile based upon the at least one geometry parameter; and
storing the at least one tile in a tiles database, wherein the at least one tile is associated with the at least one map layer.

6. The computer program product of claim 5, further comprising program code for dividing the at least one map layer into the at least one tile.

7. A computer program product comprising program code for enabling browsing of at least one map layer associated with a map base, the program code comprising:
receiving a search string from a user;
communicating the search string to a server;
receiving at least one search result from the server;
causing the display of the at least one search result;
receiving selection of a selected result; and
causing the display of a map layer that corresponds to the selected result, wherein the map layer is displayed as a semi-transparent image superimposed upon the map base at a location specified by a position coordinates parameter associated with the map layer.

8. The computer program product of claim 7, the program code further comprising:
communicating a request for the map layer to the server; and
receiving the map layer from the server.

9. The computer program product of claim 7, wherein a size and an orientation of the map layer are based upon at least one geometry parameter associated with the map layer.

10. The computer program product of claim 7, further comprising
program code for adjusting an opacity value of the semi transparent image.

11. A computer enabled method of enabling contribution of a map layer to annotate a map base, the method comprising:
receiving the at least one map layer from a user;
causing the display of the at least one map layer as a semi-transparent image on the map base in a position relative to the map base, in response to receipt of at least one geometry parameter, wherein the position is based upon the at least one geometry parameter; and
communicating the at least one map layer to a server for storage.

12. The method of claim 11, wherein the method is executed on a web browser.

13. The method of claim 11, wherein the at least one geometry parameter comprises a position coordinates parameter, a layer dimensions parameter, a layer orientation parameter, or a combination thereof.

14. The method of claim 13, wherein the location of the semi-transparent image on the map base is based upon the position coordinates parameter.

15. The method of claim 13, wherein the size of the semi-transparent image is based upon the layer dimensions parameter.

16. The method of claim 13, wherein the orientation of the semi-transparent image is based upon the layer orientation parameter.

17. The method of claim 13, further comprising moving the semi-transparent image in response to user input received via the web browser.

18. The method of claim 13, further comprising scaling the semi-transparent image in response to user input received via the web browser.

19. The method of claim 13, further comprising rotating the semi-transparent image in response to user input received via the web browser.

20. The method of claim 11, further comprising, at the server:
storing the map layer and the at least one geometry parameter in a layers database.

21. The method of claim 20, further comprising, at the server:
generating at least one tile based upon the map layer, wherein a scale and an orientation of the tile are based upon the at least one geometry parameter; and
storing the at least one tile in the layers database.

22. The method of claim 20, further comprising, at the server:
storing a plurality of zoom level representations in the layers database,
wherein the plurality of zoom level representations comprises images that represent the at least one tile at a plurality of scales that correspond to the plurality of zoom level representations.

23. A computer-enabled method of maintaining a layers database on a server, the method comprising:
receiving an image from a web browser via a computer network;
receiving at least one geometry parameter from the web browser via the computer network, wherein the at least one geometry parameter is associated with the image; and
storing the image and the at least one geometry parameter in the layers database.

24. The method of claim 23, further comprising:
generating at least one tile based upon the image, wherein a scale and an orientation of the at least one tile are based upon the at least one geometry parameter; and
storing the at least one tile in the layers database.

25. A computer enabled method of enabling discovery of a map layer, the method comprising:
causing the display of a layer discovery user interface for discovering at least one map layer via a web browser, wherein the at least one map layer is associated with at least one map location on a map base,
wherein the layer discovery user interface is operable to:
receive a desired location via the web browser,
communicate the desired location to a server,
receive a map layer from the server, wherein the map layer is associated with the desired location,
cause the display of the map layer as a semi-transparent image superimposed on at least a portion of the map base, and
wherein the portion of the map base overlaid by the map layer is defined by at least one geometry parameter associated with the map layer.

26. The method of claim 25, wherein the map layer comprises at least one tile, and the layer discovery user interface is operable to cause the display of the at least one tile on the map base, wherein the location at which the at least one tile is displayed is defined by at least one geometry parameter associated with the at least one tile.

27. The method of claim 25, wherein the layer discovery user interface is operable to cause partial color blending of the map layer with the at least a portion of the map base to allow features of the map layer and features of the at least a portion of the map base to be visible, wherein the degree to which features of the at least a portion of the map base are visible is based upon an opacity value.

28. The method of claim 25, further comprising, at the server:
receiving the desired location;
retrieving the map layer from the layers database; and
communicating the map layer to the layer discovery user interface.

29. A computer-enabled method of providing map layers, the method to be invoked by a web server, the method comprising:
receiving a desired location from a client via a computer network;
retrieving a map layer from a layers database, wherein the map layer corresponds to the desired location;
communicating the map layer to the client.

30. The method of claim 29, wherein the map layer comprises at least one image, at least one text annotation, or a combination thereof.

31. An interface for receiving at least one map layer to annotate a map base, the interface comprising:
an input portion for receiving the at least one map layer; and
an overlay for displaying the at least one map layer as a semi-transparent image, the semi-transparent image adjusting in response to input received from a user,
wherein the interface is located on a web browser.

32. The interface of claim 31, wherein the overlay is operable to move the semi-transparent image in response to user input received via the web browser.

33. The interface of claim 31, wherein the overlay is operable to scale the semi-transparent image in response to user input received via the web browser.

34. The interface of claim 31, wherein the overlay is operable to rotate the semi-transparent image in response to user input received via the web browser.

35. An interface for displaying at least one map layer as an overlay on a map base, the interface comprising:
an input portion for receiving a search string from a user;
a display for displaying at least one search result, wherein the at least one search result matches the search string;
an input portion for receiving selection of a selected result,
wherein the at least one map layer corresponds to the selected result,
wherein the at least one map layer is displayed as a semi-transparent image at a location specified by a position coordinates parameter associated with the at least one map layer, and
wherein the interface is located on a web browser.

36. The interface of claim 35, further comprising
an opacity control for adjusting an opacity value of the semi transparent image.

37. The interface of claim 35, wherein a size and an orientation of the at least one semi-transparent image are based upon at least one geometry parameter associated with the map layer.

38. The interface of claim 37, wherein the at least one geometry parameter comprises a position coordinates parameter, a layer dimensions parameter, a layer orientation parameter, or a combination thereof.

39. The interface of claim 38, wherein the location of the semi-transparent image on the map base is based upon the position coordinates parameter.

40. The interface of claim 38, wherein the size of the semi-transparent image is based upon the layer dimensions parameter.

41. The interface of claim 38, wherein the orientation of the semi-transparent image is based upon the layer orientation parameter.

42. An apparatus for receiving at least one map layer to annotate a map base, the apparatus comprising:
input logic for receiving the at least one map layer; and
display logic for displaying the at least one map layer as a semi-transparent image, the semi-transparent image adjusting in response to input received from a user,
wherein the interface is located on a web browser.

43. The apparatus of claim 42, wherein the display logic is operable to move, rotate, and scale the semi-transparent image in response to user input received via the web browser.

44. An apparatus for displaying at least one map layer as an overlay on a map base, the apparatus comprising:
input logic for receiving a search string from a user;
display logic for displaying at least one search result, wherein the at least one search result matches the search string;
input logic for receiving selection of a selected result,
wherein the at least one map layer corresponds to the selected result,
wherein the at least one map layer is displayed as a semi-transparent image at a location specified by a position coordinates parameter associated with the at least one map layer, and
wherein the apparatus is located on a web browser.

45. The apparatus of claim 44, further comprising
opacity control logic for adjusting an opacity value of the semi transparent image.

46. The apparatus of claim 44, wherein a size and an orientation of the at least one semi-transparent image are based upon at least one geometry parameter associated with the map layer.

47. The apparatus of claim 46, wherein the at least one geometry parameter comprises a position coordinates parameter, a layer dimensions parameter, a layer orientation parameter, or a combination thereof.

48. The apparatus of claim 47, wherein the location of the semi-transparent image on the map base is based upon the position coordinates parameter.

49. The apparatus of claim 47, wherein the size of the semi-transparent image is based upon the layer dimensions parameter.

50. The apparatus of claim 47, wherein the orientation of the semi-transparent image is based upon the layer orientation parameter.
